(19) United States
(12) Patent Application Publication
(10) Pub. No.: US 2013/0265477 A1
(43) Pub. Date: Oct. 10, 2013

(54) OPTICAL DEVICE, IMAGE-CAPTURING APPARATUS, ELECTRONIC APPARATUS, AND METHOD FOR PRODUCING OPTICAL DEVICE

(71) Applicant: SEIKO EPSON CORPORATION, Tokyo (JP)

(72) Inventors: Daiki FURUSATO, Ina (JP); Yuta HOSHINO, Minowa (JP)

(73) Assignee: Seiko Epson Corporation, Tokyo (JP)

(21) Appl. No.: 13/859,391

(22) Filed: Apr. 9, 2013

(30) Foreign Application Priority Data
Apr. 10, 2012 (JP) 2012-089616

(51) Int. Cl. G02B 1/11

(52) U.S. Cl. CPC G02B 1/11
USPC 348/335; 359/601; 427/162

(57) ABSTRACT

An optical device includes an inorganic light-transmissive base material, a hard coat layer, which is provided on a principal surface of the light-transmissive base material and is harder than the light-transmissive base material, and an organic antireflection layer, which is provided on a principal surface of the hard coat layer and contains an organosilicon compound, an epoxy group-containing organic compound, and hollow silica. The hard coat layer and at least one of the organosilicon compound and the epoxy group-containing organic compound are covalently bonded to each other. The occurrence of a defect in the organic antireflection layer can be prevented. The organic antireflection layer has a higher dust-proof effect than an inorganic antireflection film, and therefore, dirt, dust, etc. hardly adhere thereto.

### BACKGROUND

1. Technical Field

The present invention relates to an optical device, an image-capturing apparatus including an optical device, an electronic apparatus including an optical device, and a method for producing an optical device.

2. Related Art

An image-capturing apparatus is used in a digital camera, etc. Such an image-capturing apparatus has a structure in which an image-capturing device such as CCD is provided on the bottom of a container, a lid disposed facing the image-capturing device is attached to the container, and an optical low-pass filter along with the lid is disposed facing the image-capturing device.

Some optical devices such as a lid and an optical low-pass filter are configured such that an antireflection film is formed on a light-transmissive substrate composed of an inorganic material.

As the antireflection film, there is known an antireflection film as a related art example which is composed of an inorganic material and is configured such that a layer containing a mixed oxide film of titanium and lanthanum as a main component and a layer containing a silicon oxide film as a main component are laminated on a quartz crystal base material (JP-A-2008-32874 (PTL 1)). In PTL 1, the antireflection film composed of an inorganic material is formed on a quartz crystal base material by a vacuum vapor deposition method.

Further, as related art examples, there are known an antireflection film which has a material composed of a reaction product of silica particles and an organopolysiloxane and a thin film obtained by curing a curable silicone resin in which this material is dispersed on a surface of a base material composed of a glass or a plastic (JP-A-2011-88787 (PTL 2)), an antireflection film in which a high-refractive index layer is provided on one surface of a base material film made of a resin, and a low-refractive index layer containing hollow silica is provided on this high-refractive index layer (JP-A-2011-237802 (PTL 3)), an antireflection film in which a hard coat film, a low-refractive index layer containing hollow silica, and an antifouling layer are sequentially laminated on one surface of a transparent plastic base material, and a surface of the hard coat film is treated with an alkali (JP-A-2002-277604 (PTL 4)), and an antireflection film in which a hard coat film is provided on a base material film composed of biaxially-oriented polyethylene terephthalate, and on this hard coat film, a low-refractive index layer containing a disilane compound and hollow silica particles treated with a silane coupling agent is provided (JP-A-2009-157233 (PTL 5)).

In the related art disclosed in PTL 1, since a vacuum vapor deposition method is used for forming an antireflection film, a series of operations such as setting a base material which is a vapor deposition target on a jig, setting the jig in a dome, carrying the dome in a vapor deposition apparatus, vacuuming in the vapor deposition apparatus, and vapor depositing an inorganic antireflection film are required. In the related art disclosed in PTL 1, such a series of complicated and troublesome steps are required, and therefore there is a problem that operational control items are increased, it takes a lot of time and labor to form a film, and as a result, the production cost is increased. Moreover, there is also a problem that due to particles, dirt, dust, etc. generated during the operations from setting a base material on a jig to vacuuming in a vapor deposition apparatus, a disadvantage that an antireflection film with a defect is formed is caused. Further, there is also a problem that in the case of using a mixed oxide film obtained by mixing titanium and lanthanum as a material of the antireflection film or the like, uranium (U) or thorium (Th), each of which is a radioactive element, may be sometimes incorporated in the mixed oxide film as impurities, and therefore, due to radiation (α ray) emitted from such an element, a defect occurs in a light-receiving section of an image-capturing device, or other disadvantage is caused. Still further, there is a disadvantage that after film formation, dirt or dust adheres to a silicon oxide film constituting the antireflection film, for example, disposed as the outermost layer, and therefore there is a problem that a high quality cannot be maintained.

The related art disclosed in PTL 2 aims at improving spectroscopic properties, and does not solve the above-described disadvantages caused in the related art in PTL 1. Moreover, the related art disclosed in PTL 2 has a configuration such that an antireflection film is directly provided on a base material, and is not premised on the existence of a hard coat film.

The related art disclosed in PTL 3 is configured such that a low-refractive index layer is provided on a film base material made of a resin, and is not an antireflection film formed on a light-transmissive substrate made of an inorganic material.

The related art disclosed in PTL 4 is configured such that a low-refractive index layer is provided on a transparent plastic substrate, and is not an antireflection film formed on a light-transmissive substrate made of an inorganic material in the same manner as in PTL 3.

The related art disclosed in PTL 5 is configured such that a low-refractive index layer is provided on a base material film composed of biaxially-oriented polyethylene terephthalate, and is not an antireflection film formed on a light-transmissive substrate made of an inorganic material in the same manner as in PTL 4.

### SUMMARY

An advantage of some aspects of the invention is to provide an optical device in which a high-quality antireflection layer can be easily formed on a hard coat layer made of an inorganic material, an image-capturing apparatus, an electronic apparatus, and a method for producing an optical device.

The invention can be implemented as the following forms or application examples.

### Application Example 1

An optical device according to this application example includes: an inorganic light-transmissive base material; an inorganic hard coat layer, which is provided on a principal surface of the light-transmissive base material and is harder than the light-transmissive base material; and an organic antireflection layer, which is provided on a principal surface of the hard coat layer and contains an organosilicon compound, an epoxy group-containing organic compound, and hollow silica, and the hard coat layer and at least one of the organosilicon compound and the epoxy group-containing organic compound are covalently bonded to each other.

According to this application example having such a configuration, the hard coat layer is an inorganic layer, and therefore, an —OH group is present on a surface thereof. An organosilicon compound or an epoxy group-containing organic compound has a reaction mechanism of a hydrolysis reaction or a condensation reaction and undergoes such a reaction with the —OH group, whereby the compound is bonded to the hard coat layer through a hydrogen bond or a covalent bond. Further, by setting the ratio of the hollow silica to the organic antireflection layer or the size of the hollow silica, the refractive index of the organic antireflection layer is set to a desired value.

Accordingly, since an organic material is used instead of an inorganic material as the organic antireflection layer in this application example, it is not necessary to use a vacuum vapor deposition method for forming a film. Therefore, a factor causing the adhesion of dirt, dust, etc. to a principal surface of the hard coat layer during film formation is significantly decreased, and thus, the film formation can be reliably performed and the occurrence of a defect in the antireflection film can be prevented. Further, since the contact angle of an organic antireflection layer is larger than that of an antireflection layer made of an inorganic material, after film formation, the adhesion of dirt, dust, etc. to the organic antireflection layer is less likely to occur, and therefore, the dust-proof performance can be enhanced. Further, the organic antireflection layer is composed of an organic material and does not contain a mixed oxide film of titanium and lanthanum, and therefore, uranium (U) or thorium (Th), each of which is a radioactive element, is not contained in the material as impurities, and thus, there are no adverse effects of radiation (α ray) emitted from such an element on an electronic apparatus such as an image-capturing apparatus which is disposed near the optical device.

### Application Example 2

In the optical device according to the application example, the thickness d of the organic antireflection layer satisfies the following formula: d=λ/(4×n), wherein n represents the refractive index of the organic antireflection layer and λ represents the wavelength of a transmitted light.

According to this application example having such a configuration, the thickness of the organic antireflection layer is set on the basis of the formula for designing a thin film of d=λ/(4×n), and therefore, an organic antireflection layer having a high antireflection effect can be provided.

### Application Example 3

In the optical device according to the application example, the thickness d of the organic antireflection layer satisfies the following formula: 67 nm≦d≦151 nm.

According to this application example having such a configuration, in consideration of the wavelength range of a light to be used in each of various electronic apparatuses such as a pickup apparatus, a liquid crystal projector, and a camera, the thickness of the organic antireflection layer is set to an appropriate value. Accordingly, the antireflection effect of the optical device to be used in each apparatus can be increased.

### Application Example 4

In the optical device according to the application example, the light-transmissive base material contains an Si group.

According to this application example having such a configuration, in various optical products, as the inorganic material of the light-transmissive base material, a material containing an Si group, for example, a material which is easily obtained such as quartz crystal, lithium niobate, or a glass is selected, and therefore, the optical device can be easily produced.

### Application Example 5

An image-capturing apparatus according to this application example includes: the optical device according to the application example; an image-capturing device; and a container which houses the image-capturing device.

According to this application example having such a configuration, the image-capturing apparatus includes the optical device having the above-described effect, and therefore, reflection of a defect on the image-capturing device caused by a defect in the optical device is significantly decreased, and a high-quality image-capturing apparatus without causing reflection of dirt, dust, etc. on the image-capturing device can be provided.

### Application Example 6

An electronic apparatus according to this application example includes the optical device according to the application example.

According to this application example having such a configuration, the electronic apparatus includes the optical device having the above-described effect, and therefore, a high-quality electronic apparatus without causing reflection of dirt, dust, etc. can be provided.

### Application Example 7

A method for producing an optical device according to this application example includes: preparing an inorganic light-transmissive base material and forming an inorganic hard coat layer, which is harder than the light-transmissive base material, on a principal surface of the light-transmissive base material; preparing a solution bath containing a solution containing an organosilicon compound, an epoxy group-containing organic compound, and hollow silica; dipping the light-transmissive base material having the hard coat layer formed thereon in the bath to coat the hard coat layer with the solution; and heating the light-transmissive base material having the hard coat layer coated with the solution so as to covalently bond the hard coat layer to at least one of the organosilicon compound and the epoxy group-containing organic compound.

According to this application example having such a configuration, the organic antireflection layer is formed on the light-transmissive base material by a dip-coating method in which the light-transmissive base material having the hard coat layer formed thereon is dipped in the solution, and therefore, the control or the like of the film-forming operation becomes simpler than in the case of using a vacuum vapor deposition method for forming an inorganic antireflection layer, and as a result, an optical device with less defects can be produced at low cost.

### Application Example 8

A method for producing an optical device according to this application example includes: preparing an inorganic light-transmissive base material and forming an inorganic hard coat layer, which is harder than the light-transmissive base material, on a principal surface of the light-transmissive base material; preparing a solution containing an organosilicon compound, an epoxy group-containing organic compound, and hollow silica; applying and spin-coating the solution onto the hard coat layer; and heating the light-transmissive base material having the hard coat layer spin-coated with the solution so as to covalently bond the hard coat layer to at least one of the organosilicon compound and the epoxy group-containing organic compound.

According to this application example having such a configuration, the organic antireflection layer is formed on the hard coat layer by a spin-coating method in which the solution is applied dropwise to the hard coat layer unified with the light-transmissive base material and rotating the base material, and therefore, in the same manner as in the case of using a dip-coating method, an optical device with less defects can be produced easily at low cost, and also the thickness of the organic antireflection layer can be more easily adjusted than in the case of using a dip-coating method.

### BRIEF DESCRIPTION OF THE DRAWINGS

The invention will be described with reference to the accompanying drawings, wherein like numbers reference like elements.

FIG. 1 is an enlarged cross-sectional view showing a part of an optical device according to an embodiment of the invention.

FIG. 2 is a graph showing a relationship between a wavelength λ in a wavelength range of a light to be used and a reflectance R (%) of an organic antireflection layer.

FIG. 3 is a schematic diagram for illustrating one example of producing an optical device.

FIGS. 4A to 4E are schematic diagrams for illustrating another example of producing an optical device.

FIG. 5 is a schematic diagram showing an image-capturing apparatus having the optical device according to the embodiment incorporated therein.

FIG. 6 is a schematic diagram showing one example of an electronic apparatus having the optical device according to the embodiment incorporated therein.

FIG. 7 is a schematic diagram showing one example of an electronic apparatus having the optical device according to the embodiment incorporated therein.

FIG. 8 is a schematic diagram showing one example of an electronic apparatus having the optical device according to the embodiment incorporated therein.

### DESCRIPTION OF EXEMPLARY EMBODIMENTS

Embodiments of the invention will be described with reference to the accompanying drawings.

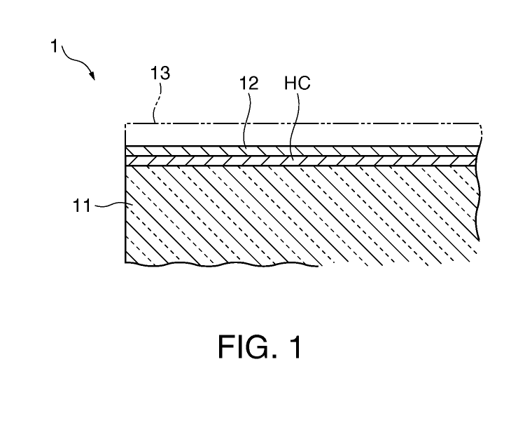

FIG. 1 is a cross-sectional view of a main part of an optical device 1 according to an embodiment.

In FIG. 1, the optical device 1 includes a light-transmissive base material 11, a hard coat layer HC provided on a principal surface of the light-transmissive base material 11, and an organic antireflection layer 12 provided on a principal surface of the hard coat layer HC. The organic antireflection layer 12 is provided on either one or both of the two principal surfaces of the light-transmissive base material 11.

In this embodiment, a water-repellent film 13 may be provided on the organic antireflection layer 12.

The optical device 1 is a birefringent plate, a lid, or a cover glass to be used in an image-capturing apparatus of a digital camera, or a wave plate or a dust-proof glass to be used in a liquid crystal projector and a pickup apparatus, or other optical device.

### 1. Light-Transmissive Base Material

The light-transmissive base material 11 is a plate-shaped member composed of an inorganic material.

Examples of the inorganic material include quartz crystal, lithiumniobate (LiNbO₃), sapphire, BBO, calcite, YVO₄, and a glass. Examples of the glass include an optical glass such as BK7, a white plate glass, a borosilicate glass, and a blue plate glass.

The organic antireflection layer 12 contains an organosilicon compound, an epoxy group-containing organic compound, and hollow silica, and contains an Si skeleton having an atomic structure including a siloxane (Si—O) bond and a leaving group binding to the Si skeleton, and a dangling bond of the Si skeleton from which the leaving group has been released among the Si skeletons becomes an active hand to bond the principal surface of the light-transmissive base material 11 through a siloxane bond or a covalent bond.

### 2. Hard Coat Layer

The hard coat layer HC is formed on the light transmissive base material 11. The hard coat layer HC contains at least the following “Component H1” and “Component H2”.

“Component H1”: metal oxide particles containing titanium oxide having a rutile type crystal structure; and “Component H2”: an organosilicon compound represented by the general formula: R¹SiX¹₃ (wherein R¹ represents an organic group having a polymerizable reactive group and having 2 or more carbon atoms, and X¹ represents a hydrolyzable group).

Examples of the “Component H1” include inorganic oxide fine particles having an average particle diameter of 1 nm or more and 200 nm or less and containing a composite oxide which has a rutile type crystal structure and is composed of titanium oxide and tin oxide, or titanium oxide, tin oxide, and silicon oxide. Examples of the “Component H2” include an organosilicon compound represented by the general formula: R¹SiX¹₃ (wherein R¹ represents an organic group having a polymerizable reactive group and having 2 or more carbon atoms, and X¹ represents a hydrolyzable group).

The hard coat layer HC is required to have a refractive index equal to that of the light-transmissive base material 11 for the purpose of preventing the occurrence of interference fringes. In order to increase the refractive index of the hard coat layer HC, a method using inorganic oxide fine particles having a high refractive index is generally employed, and specifically, colorless and transparent inorganic oxide fine particles composed of a composite oxide containing one or more metal oxides selected from Al, Sn, Sb, Ta, Ce, La, Fe, Zn, W, Zr, In and Ti oxides (including a mixture thereof) and/or two or more metals are used.

Among these, from the viewpoint of refractive index, transparency, dispersion stability, etc., inorganic oxide fine particles containing titanium oxide are generally used. However, titanium oxide has a property that it is activated when receiving a light (UV ray) energy and decomposes an organic substance by a high oxidative decomposition ability. Therefore, when titanium oxide is contained as a constituent component of the hard coat layer, there is a tendency that an organic substance such as a silane coupling agent which is another main constituent component is decomposed due to photoactivity to cause cracking or film peeling in the hard coat layer and deteriorate the quality of durability. Therefore, in this embodiment, it is preferred to use a metal oxide containing titanium oxide having a rutile type crystal structure. By changing the crystal structure of the metal oxide containing titanium oxide to a rutile type in place of an anatase type, the weather resistance and light resistance are further improved, and also the refractive index of the rutile type crystal is higher than that of the anatase crystal, and therefore, inorganic oxide fine particles having a relatively high refractive index can be obtained.

Unlike titanium oxide having an anatase type crystal structure having a property that it is activated when receiving a light (UV ray) energy and decomposes an organic substance by a high oxidative decomposition ability, titanium oxide having a rutile type crystal structure has such a photoactivity which is low. The reason for this is as follows. When a light (UV ray) is irradiated, an electron in the valence band of titanium oxide is excited to generate an OH free radical and a HO₂ free radical, and thus an organic substance is decomposed by the resulting high oxidative ability, however, since rutile type titanium oxide is more stable in terms of thermal energy than anatase type titanium oxide, the production amount of such a free radical is extremely small in the case of rutile type titanium oxide. Accordingly, the hard coat layer HC containing titanium oxide having a rutile type crystal structure has excellent weather resistance and light resistance, and therefore, there is no fear that the antireflections layer 12 constituted by an organic thin film is deteriorated by the hard coat layer HC, and thus, the optical device 1 having excellent weather resistance and light resistance can be obtained.

As a method for obtaining titanium oxide having a rutile type crystal structure, it is preferred to provide a composite oxide with tin oxide, and further, a composite oxide obtained by further adding silicon oxide to the above composite oxide. When the composite oxide with tin oxide is added, the amounts of titanium oxide and tin oxide contained in the inorganic oxide fine particles are desirably such that the weight ratio of TiO₂/SnO₂ is 1/3 or more and 20/1 or less, preferably 1.5/1 or more and 13/1 or less when the amount of titanium oxide is converted into that of TiO₂ and the amount of tin oxide is converted into that of SnO₂.

As the amount of SnO₂ is decreased below the above-described range of the weight ratio, the crystal structure shifts from the rutile type to the anatase type to form a mixed crystal containing the rutile type crystal and the anatase type crystal, or form the anatase type crystal. On the other hand, as the amount of SnO₂ is increased beyond the above-described range of the weight ratio, a rutile type crystal structure that is in the intermediate of rutile type crystal of titanium oxide and rutile type crystal of tin oxide is formed, and the crystal exhibits a crystal structure different from the so-called rutile type crystal of titanium oxide. In addition, the refractive index of the resulting inorganic oxide fine particles is also decreased.

Further, when the composite oxide with tin oxide and the composite oxide obtained by further adding silicon oxide to the above composite oxide, the amounts of titanium oxide, tin oxide, and silicon oxide contained in the inorganic oxide fine particles are desirably such that the weight ratio of TiO₂/SnO₂ is 1/3 or more and 20/1 or less, preferably 1.5/1 or more and 13/1 or less, and the weight ratio of (TiO₂+SnO₂)/SiO₂ is 55/45 or more and 99/1 or less, preferably 70/30 or more and 98/2 or less, when the amount of titanium oxide is converted into that of TiO₂, the amount of tin oxide is converted into that of SnO₂, and the amount of silicon oxide is converted into that of SiO₂.

The content of SnO₂ is the same as in the case where the composite oxide with tin oxide is added, and by incorporating silicon oxide therein, the stability and dispersibility of the resulting inorganic oxide fine particles can be improved.

The contents of titanium oxide and tin oxide, or the contents of titanium oxide, tin oxide, and silicon oxide contained in a core particle are the same as in the case described above, however, the contents of silicon oxide, zirconium oxide, and aluminum oxide contained in a coating layer are preferably selected from the ranges shown in the following (a) to (c) according to a combination of oxides in the composite oxide to be used.

(a) In the case where the coating layer is formed from a composite oxide of silicon oxide and zirconium oxide, the amounts of silicon oxide and zirconium oxide contained in the coating layer are desirably such that the weight ratio of SiO₂/ZrO₂ is 50/50 or more and 99/1 or less, preferably 65/35 or more and 90/10 or less when the amount of silicon oxide is converted into that of SiO₂ and the amount of zirconium oxide is converted into that of ZrO₂.

If the amount of ZrO₂ is more than the above-described range of the weight ratio, Zr atom which can trap a free radical is increased, however distortion is caused in a coating layer and a dense coating layer is not be formed. Therefore, a free radical generated in the core particle comes out on the surface of the inorganic oxide fine particle, thereby leading to the oxidation of the organic substance. On the other hand, if the amount of ZrO₂ is less than the above-described range of the weight ratio, it becomes easy to form a dense coating layer, however, a free radical generated in the core particle comes out on the surface of the inorganic oxide fine particle because the amount of Zr atom for trapping the free radical is small, thereby leading to the oxidation of the organic substance.

(b) In the case where the coating layer is formed from a composite oxide of silicon oxide and aluminum oxide, the amounts of silicon oxide and aluminum oxide contained in the coating layer are desirably such that the weight ratio of SiO₂/Al₂O₃ is 60/40 or more and 99/1 or less, preferably 68/32 or more and 95/5 or less when the amount of silicon oxide is converted into that of SiO₂ and the amount of aluminum oxide is converted into that of Al₂O₃.

If the amount of Al₂O₃ is more than the above-described range of the weight ratio, Al atom which can trap a free radical is increased, however a dense coating layer cannot be formed. Therefore, a free radical generated in the core particle comes out on the surface of the inorganic oxide fine particle, thereby leading to the oxidation of the organic substance. On the other hand, if the amount of Al₂O₃ is less than the above-described range of the weight ratio, it becomes easy to form a dense coating layer, however, a free radical generated in the core particle comes out on the surface of the inorganic oxide fine particle because the amount of Al atom for trapping the free radical is small, thereby leading to the oxidation of the organic substance.

(c) In the case where the coating layer is formed from a composite oxide of silicon oxide, zirconium oxide, and aluminum oxide, the amounts of silicon oxide, zirconium oxide, and aluminum oxide contained in the coating layer are desirably such that the weight ratio of SiO₂/(ZrO₂+Al₂O₃) is 98/2 or more and 6/4 or less, preferably 95/5 or more and 7/3 or less when the amount of silicon oxide is converted into that of SiO₂, the amount of zirconium oxide is converted into that of ZrO₂, and the amount of aluminum oxide is converted into that of Al₂O₃.

If the total amount of ZrO₂ and Al₂O₃ is more than the above-described range of the weight ratio, the total amount of Zr atom and Al atom which can trap a free radical is increased, however a dense coating layer cannot be formed. Therefore, a free radical generated in the core particle comes out on the surface of the inorganic oxide fine particle, thereby leading to the oxidation of the organic substance. On the other hand, if the total amount of ZrO₂ and Al₂O₃ is less than the above-described range of the weight ratio, it becomes easy to form a dense coating layer, however, a free radical generated in the core particle comes out on the surface of the inorganic oxide fine particle because the total amount of Zr atom and Al atom for trapping the free radical is small, thereby leading to the oxidation of the organic substance. Further, it is desirable that the coating layer has a thickness of 0.02 nm or more and 2.27 nm or less, preferably 0.16 nm or more and 1.14 nm or less from the viewpoint of preventing a free radical generated in the core particle from coming out on the surface of the inorganic oxide fine particle to lead to the oxidation of the organic substance.

The composite oxide constituting the core particle as used herein refers to a composite solid solution oxide composed of titanium oxide and tin oxide (including a doped composite oxide) and/or a composite oxide cluster composed of the same, or a composite solid solution oxide composed of titanium oxide, tin oxide, and silicon oxide (including a doped composite oxide) and/or a composite oxide cluster composed of the same. Further, the composite oxide constituting the core particle and/or the coating layer may be a composite hydrous oxide having an OH group at the end, or may be one further containing a composite hydrous oxide in part.

It is desirable that the inorganic oxide fine particles containing titanium oxide have an average particle diameter of 1 nm or more and 200 nm or less, preferably 5 nm or more and 30 nm or less. When the average particle diameter thereof is less than 1 nm, bridge formation between the particles may be caused in the drying step for forming the hard coat layer on the plastic lens base material, and thus the layer is not uniformly contracted and further the contraction ratio thereof is decreased. Accordingly, a hard coat layer having a sufficient film hardness cannot be obtained. On the other hand, when the average particle diameter exceeds 200 nm, the hard coat layer HC is whitened, and becomes unsuitable for use in optical components.

Additionally, the inorganic oxide fine particles containing titanium oxide having a rutile type crystal structure may be used alone or in combination with other inorganic oxide particles. Examples of such other inorganic oxide particles include inorganic oxide fine particles composed of a composite oxide containing oxides of one or more metals selected from Si, Al, Sn, Sb, Ta, Ce, La, Fe, Zn, W, Zr, and In (including mixtures thereof) and/or a composite oxide containing two or more metals.

Specific examples of the inorganic oxide fine particles include a dispersion medium prepared by dispersing inorganic oxide fine particles containing titanium oxide that has a rutile type crystal structure and having an average particle diameter of 1 nm or more and 200 nm or less in, for example, water, an alcohol or another organic solvent in a colloidal state. Examples of a commercially available dispersion medium include a dispersion sol for coating (Optlake, manufactured by Catalysts & Chemicals Industries Co., Ltd.) which contains inorganic oxide fine particles having an average particle diameter of 8 to 10 nm prepared by coating the surfaces of the core particles of a composite oxide having a rutile type crystal structure and composed of titanium oxide and tin oxide, or titanium oxide, tin oxide, and silicon oxide, with a coating layer of a composite oxide composed of silicon oxide and zirconium oxide, and/or aluminum oxide.

In order to further improve the dispersion stability in a composition for the hard coat layer, inorganic oxide fine particles obtained by treating the surfaces of the above-described inorganic oxide fine particles with an organosilicon compound or an amine compound, and further with a carboxylic acid such as tartaric acid or malic acid can be also used. Examples of the organosilicon compound which can be used at this time include a monofunctional silane, a difunctional silane, a trifunctional silane, and a tetrafunctional silane. Also, when performing the treatment, the treatment may be performed while the hydrolyzable group is in an intact state or in a hydrolyzed state. Further, although the hydrolyzable group is preferably in a state of being reacted with the —OH group of the fine particle after the hydrolysis treatment, there is no problem of stability even if some hydrolyzable groups remain unreacted.

Further, examples of the amine compound include ammonium, alkylamines such as ethylamine, triethylamine, isopropylamine and n-propylamine; aralkylamines such as benzylamine; alicyclic amines such as piperidine; and alkanolamines such as monoethanolamine and triethanolamine.

The type and the blending amount of the inorganic oxide fine particles are determined according to the intended hardness, refractive index, and the like, however, the blending amount thereof is desirably 5% by weight or more and 80% by weight or less, particularly 10% by weight or more and 50% by weight or less of the solid content in the composition for the hard coat layer. If the blending amount thereof is too small, the abrasion resistance of the coating film may be insufficient in some cases. On the other hand, if the blending amount thereof is too large, a crack may occur in the coating film and also the stainability may be insufficient in some cases.

Next, the “Component H2” will be described. The “Component H2” plays a role as a binder agent for the hard coat layer HC. In the general formula of the “Component H2”, R¹ represents an organic group having a polymerizable reactive group and having 2 or more carbon atoms. R¹ has a polymerizable reactive group such as a vinyl group, an allyl group, an acryl group, a methacryl group, a 1-methylvinyl group, an epoxy group, a mercapto group, a cyano group, an isocyano group, or an amino group. Further, X¹ represents a hydrolyzable functional group, and examples thereof include an alkoxy group such as a methoxy group, an ethoxy group, and a methoxyethoxy group; a halogen group such as a chloro group and a bromo group; and an acyloxy group.

Examples of the organosilicon compound of the “Component H2” include vinyltrialkoxysilane, vinyltrichlorosilane, vinyltri(β-methoxy-ethoxy)silane, allyltrialkoxysilane, acryloxypropyltrialkoxysilane, methacryloxypropyltrialkoxysilane, γ-glycidoxypropyltrialkoxysilane, β-(3,4-epoxycyclohexyl)-ethyltrialkoxysilane, mercaptopropyltrialkoxysilane, and γ-aminopropyltrialkoxysilane. The organosilicon compound of the “Component H2” may be used as a mixture of two or more types thereof.

When the composition for the hard coat layer is produced by mixing the “Component H1” and the “Component H2”, it is preferred to mix a sol having the “Component H1” dispersed therein and the “Component H2”. The blending amount of the “Component H1” is determined according to the hardness, refractive index, and the like of the hard coat layer HC, but is preferably 5% by weight or more and 80% by weight or less, particularly 10% by weight or more and 60% by weight or less of the solid content in the composition. If the blending amount thereof is too small, the abrasion resistance of the hard coat layer HC may be insufficient in some cases. On the other hand, if the blending amount thereof is too large, a crack may occur in the hard coat layer HC in some cases.

Further, a curing catalyst may also be added to the composition for the hard coat layer. Examples of the curing catalyst include perchloric acids such as perchloric acid, ammonium perchlorate, and magnesium perchlorate; acetylacetonate having Cu(II), Zn(II), Co(II), Ni(II), Be(II), Ce(III), Ta(III), Ti(III), Mn(III), La(III), Cr(III), V(III), Co(III), Fe(III), Al(III), Ce(IV), Zr(IV), V(IV), or the like as a central metal atom; amines; amino acids such as glycine; Lewis acid; and organic acid metal salts. Among these, examples of a preferred curing catalyst include magnesium perchlorate, acetylacetonate having Al(III) or Fe(III) as a central metal atom. In particular, acetylacetonate having Fe(III) as a central metal atom is most preferably used. It is desirable that the addition amount of the curing catalyst is 0.01% by weight or more and 5.0% by weight or less of the solid content concentration in the composition for the hard coat layer.

The thus obtained composition for the hard coat layer can be used by being diluted with a solvent as needed. As the solvent, a solvent such as an alcohol, an ester, a ketone, an ether, or an aromatic solvent is used. If necessary, a small amount of a metal chelating compound, a surfactant, an antistatic agent, a UV absorbing agent, an antioxidant, a disperse dye, an oil-soluble dye, a pigment, a photochromic compound, a light and heat resistant stabilizer such as hindered amine or hindered phenol, or the like can be added to the coating composition for forming the hard coat layer to improve the application performance and curing speed of the coating composition, and the performance of the resulting coating film after curing.

In this embodiment, a primer layer may be provided between the light-transmissive base material 11 and the hard coat layer HC.

### 3. Organic Antireflection Layer

The organic antireflection layer 12 is directly formed on a principal surface of the hard coat layer HC.

The organic antireflection layer 12 is an organic thin film having a refractive index lower than that of the light-transmissive base material 11 by 0.10 or more, and contains at least “Component A1”: an organosilicon compound represented by the general formula: XₘR²₃₋ₘSi—Y—SiR²₃₋ₘXₘ (wherein R² represents a monovalent hydrocarbon group having 1 to 6 carbon atoms; Y represents a divalent organic group having 1 or more fluorine atoms; X represents a hydrolyzable group; and m represents an integer of 1 to 3), “Component A2”: an epoxy group-containing organic compound containing one or more epoxy groups per molecule, and “Component A3”: silica-based fine particles having an average particle diameter of 20 nm or more and 150 nm or less.

The “Component A1” is an organosilicon compound represented by the general formula: XₘR²₃₋ₘSi—Y—SiR²₃₋ₘXₘ, and Y in the formula is a divalent organic group having 1 or more fluorine atoms, and the number of fluorine atoms is preferably 4 to 50, particularly preferably 4 to 24. In particular, in order to allow the antireflection layer to favorably exhibit various functions such as an antireflection function, an antifouling function, and a water-repellent function, it is preferred that a large amount of fluorine atoms are contained. However, if the amount of fluorine atoms is too large, the crosslinking density is decreased, and as a result, sufficient abrasion resistance may not be obtained in some cases. Therefore, as Y, a group having a structure shown below is preferred.

—CH₂CH₂(CF₂)ₙCH₂CH₂—

C₂H₄—CF(CF₃)—(CF₂)ₙ—CF(CF₃)—C₂H₄—

In the above structures, n should satisfy a range of 2 to 20, however, more preferably, n satisfies a range of 2 to 12, particularly preferably a range of 4 to 10. If n is smaller than this range, various functions such as an antireflection function, an antifouling function, and a water-repellent function, and also chemical resistance cannot be sufficiently obtained in some cases. On the other hand, if n is too large, the crosslinking density is decreased, and as a result, sufficient abrasion resistance may not be obtained in some cases.

In this embodiment, a configuration in which the “Component A1” does not contain a fluorine atom may be adopted.

R² represents a monovalent hydrocarbon group having 1 to 6 carbon atoms, and specific examples thereof include an alkyl group such as a methyl group, an ethyl group, a propyl group, a butyl group, a hexyl group, and a cyclohexyl group, and a phenyl group. In order to obtain favorable abrasion resistance, a methyl group is preferred.

m is an integer of 1 to 3, but is preferably set to 2 or 3, and particularly, in order to form a coating film having a high hardness, m is preferably set to 3.

X represents a hydrolyzable group, and specific examples thereof include a halogen atom such as Cl, an organooxy group represented by ORX (wherein RX is a monovalent hydrocarbon group having 1 to 6 carbon atoms), particularly an alkoxy group such as a methoxy group, an ethoxy group, a propoxy group, an isopropoxy group, and a butoxy group; an alkenoxy group such as an isopropenoxy group; an acyloxy group such as an acetoxy group; a ketoxime group such as a methylethylketoxime group; and an alkoxyalkoxy group such as a methoxyethoxy group. Among these, an alkoxy group is preferred, particularly, a silane compound including a methoxy group or an ethoxy group is preferred because such a silane compound is easy to handle and also a reaction thereof during hydrolysis is easy to control.

Specific examples of such a “Component A1” include the following compounds.

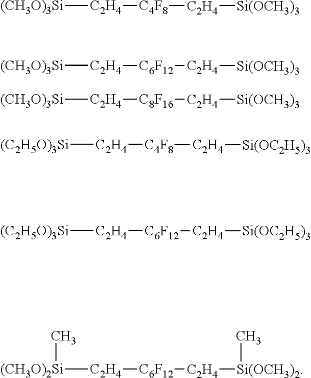

The “Component A1” is contained in an amount of 60% by weight or more and 99% by weight or less, preferably 60% by weight or more and 90% by weight or less with respect to the total amount of the resin component in a composition for an antireflection film for forming the organic antireflection layer 12. Therefore, the chemical resistance of the coating film can be improved by the organosilicon compound serving as the “Component A1”.

As the epoxy group-containing organic compound containing one or more epoxy groups per molecule serving as the “Component A2”, an appropriate compound can be used. In this composition, the epoxy group-containing organic compound is preferably contained in an amount of 5% by weight or more and 20% by weight or less with respect to the total amount of the resin component. If the amount thereof is less than this range, the cracking resistance of the coating film and the adhesiveness of the coating film to the light-transmissive base material 11 cannot be sufficiently improved, and if the amount thereof is more than this range, the abrasion resistance of the coating film may be deteriorated.

As the epoxy group-containing organic compound, preferably one selected from a compound represented by the general formula: R³ₙR⁴ₚSiZ_{4-[n+p]} (R³ and R⁴ each represent an organic group having 1 to 16 carbon atoms, and at least one of R³ and R⁴ contains an epoxy group; Z represents a hydrolyzable group; and n and p each represent an integer of 0 to 2, and satisfy the following formula: 1≦n+p≦3) and a compound represented by the following general formula (1) is used. One or more types of such compounds can be used. In this case, the cracking resistance of the coating film can be further improved without deteriorating the chemical resistance and abrasion resistance of the coating film. The total amount of these compounds is preferably 1% by weight or more and 20% by weight or less with respect to the total amount of the resin component. If the amount thereof is too small, the cracking resistance may not be able to be sufficiently improved, and if the amount thereof is too large, the chemical resistance and abrasion resistance may be deteriorated.

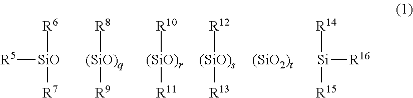

(R⁵ to R¹⁶ each represent an organic group, and at least one of R⁵ to R¹⁶ contains an epoxy group; and q, r, s, and t each represent an integer of 0 to 12.)

As the compound represented by the general formula: R³ₙR⁴ₚSiZ_{4-[n+p]}, an appropriate compound is selected according to the intended purpose such as adhesiveness to the light-transmissive base material 11, the hardness and low reflectance of the resulting film, the shelf life of the composition, etc., however, examples thereof include glycidoxymethyltrimethoxysilane, glycidoxymethyltriethoxysilane, α-glycidoxyethyltrimethoxysilane, α-glycidoxyethyltriethoxysilane, β-glycidoxyethyltriethoxysilane, β-glycidoxypropyltrimethoxysilane, α-glycidoxypropyltrimethoxysilane, α-glycidoxypropyltriethoxysilane, β-glycidoxypropyltriethoxysilane, γ-glycidoxypropyltrimethoxysilane, (3,4-epoxycyclohexyl)methyltrimethoxysilane, γ-glycidoxypropylvinyldiethoxysilane, γ-glycidoxypropylphenyldiethoxysilane, and δ-(3,4-epoxycyclohexyl)butyltriethoxysilane.

Further, with respect to the compound represented by the above general formula (1), as R⁵ to R¹⁶ in the formula, an organic group, for example, an appropriate hydrocarbon group such as a methyl group can be exemplified, and at least one of R⁵ to R¹⁶ contains an epoxy group, and examples thereof include groups having a structure shown below.

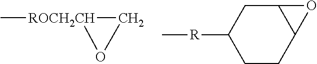

(R represents a hydrocarbon group represented by CᵤH₂ᵤ, wherein u represents an integer of 1 to 12.)

Specific examples of such a compound represented by the general formula (1) include the following compounds.

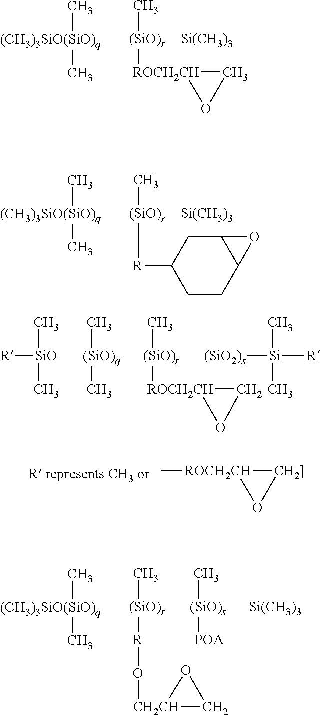

(POA represents a polyether group, preferably —C₃H₆O(C₂H₄O)ₐ(C₃H₆O)_{b}R′, wherein a and b each represent an integer of 0 to 12 and R′ represents a hydrocarbon group.)

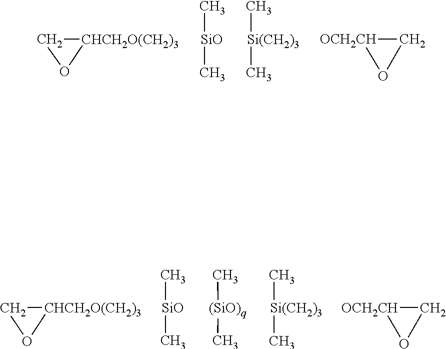

As the epoxy group-containing organic compound, other than the compound represented by the general formula: R³ₙR⁴ₚSiZ_{4-[n+p]} or the general formula (1), an appropriate epoxy compound can also be used. Examples of such an epoxy compound include the following compounds.

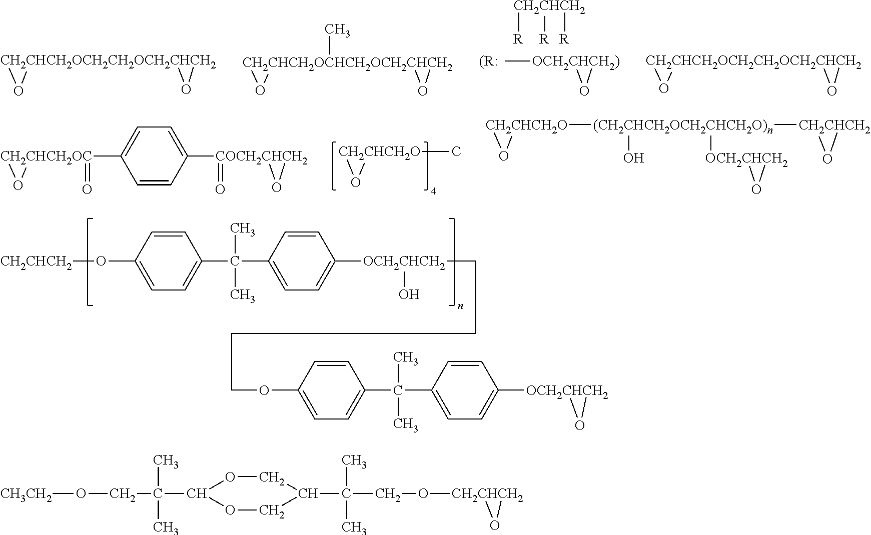

In order to decrease the refractive index, as the silica-based fine particles serving as the “Component A3”, for example, a silica sol composed of hollow silica-based fine particles having a hollow or a void formed therein is used. By incorporating a gas or a solvent having a refractive index lower than that of silica in the internal hollow of the silica-based fine particles, the refractive index is decreased as compared with the silica-based fine particles with no hollow, and thus, the refractive index of the organic antireflection layer 12 can be decreased.

As the silica-based fine particles having a hollow therein, those having an average particle diameter of 20 nm or more and 150 nm or less, preferably 40 nm or more and 60 nm or less, and most preferably 50 nm, and having a refractive index n of 1.16 to 1.39 are used. If the average particle diameter of the particles is less than 20 nm, the porosity of the internal part of the particles is decreased, and a desired low refractive index cannot be obtained. If the average particle diameter thereof exceeds 150 nm, the haze of the organic thin film is increased, and therefore, such an average particle diameter is not preferred.

In the composition for an antireflection film for forming the organic antireflection layer 12, it is also possible to use other fine particles in combination as the fine particles in addition to the “Component A3”. With respect to the total amount of these fine particles to be added, the weight ratio thereof to the other resin component is not particularly limited, however, it is preferred to set the weight ratio of the fine particles to the other components (solid components) to 80/20 or more and 10/90 or less. If the amount of the fine particles is more than the above range, the mechanical strength of the cured coating film obtained by the composition for an antireflection film may be deteriorated, and if the amount of the hollow fine particles is less than the above range, the effect of allowing the cured coating film to exhibit a low refractive index may be deteriorated.

Examples of the organosilicon compound which can be used in combination in the composition for an antireflection film for forming the organic antireflection layer 12 other than the above-described components include a variety of compounds, for example, silicates such as tetraethoxysilane; alkylsilanes such as methyltrimethoxysilane, hexyltrimethoxysilane, and decyltrimethoxysilane; phenylsilanes such as phenyltrimethoxysilane; and silane coupling agents such as γ-aminopropyltriethoxysilane and γ-mercaptopropyltrimethoxysilane.

These organosilicon compounds are preferably used in an amount of 20% by weight or less with respect to the total amount of the resin component. If the content thereof is too large, the cracking resistance of the coating film may be deteriorated or the hydrophilicity thereof may be increased to decrease the chemical resistance thereof.

Further, as the other organosilicon compound, a fluoroalkyl group-containing alkoxysilane represented by the general formula: RF—SiX₃ (wherein RF represents a monovalent organic group having one or more fluorine atoms; and X represents a hydrolyzable group) can also be incorporated. By incorporating such a compound, the refractive index of the formed coating film can be further decreased.

In the general formula: RF—SiX₃, the number of fluorine atoms in RF is preferably from 3 to 25. Above all, the following structural units are particularly preferred since a polar moiety is not contained.

CF₃C₂H₄—

CF₃(CF₂)₃C₂H₄—

CF₃(CF₂)₇C₂H₄—

X which is a hydrolyzable group can be the same group as in the “Component A1”.

Examples of the fluoroalkyl group-containing alkoxysilane represented by the general formula: RF—SiX₃ include the following compounds.

CF₃C₂H₄—Si(OCH₃)₃

CF₃(CF₂)₃C₂H₄—Si(OCH₃)₃

CF₃(CF₂)₇C₂H₄—Si(OCH₃)₃

The content of the fluoroalkyl group-containing alkoxysilane represented by the general formula: RF—SiX₃ and a hydrolysate (partial hydrolysate) thereof is appropriately adjusted, however, if the addition amount thereof is increased, the abrasion resistance of the coating film is deteriorated, and therefore, the content thereof is preferably in a range of 1 to 30% by weight, particularly preferably 10% by weight or less with respect to the total amount of the resin component in the composition.

Additional examples of the other organosilicon compound include a dialkylsiloxy-based hydrolyzable organosilane represented by the following general formula.

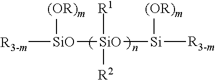

(R¹, R² and R each represent an alkyl group; m represents an integer of 1 to 3; and n represents an integer of 2 to 200.)

Examples of such a dialkylsiloxy-based hydrolyzable organosilane include compounds having a structure shown below.

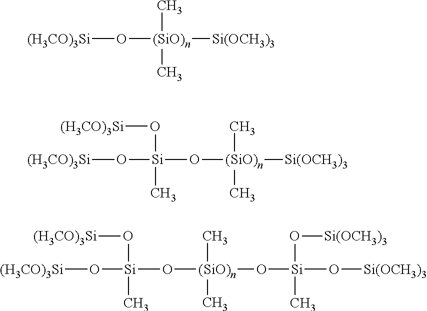

When n represents the refractive index of the organic antireflection layer 12, and λ represents a wavelength in a wavelength range of a light to be used, the thickness d of the organic antireflection layer 12 is obtained according to the formula: d=λ/(4×n) representing the condition that a light reflected from the surface of the organic antireflection layer and a light reflected from the surface of the light-transmissive base material 11 are weakened with each other.

That is, in a relationship between a wavelength λ in a wavelength range of a light to be used and a reflectance R (%) of the organic antireflection layer 12, λ₀ which represents a value of a wavelength λ that provides the minimum reflectance R is selected, and the values of this wavelength λ₀ and a known refractive index n are substituted into the above formula, whereby the thickness d is obtained.

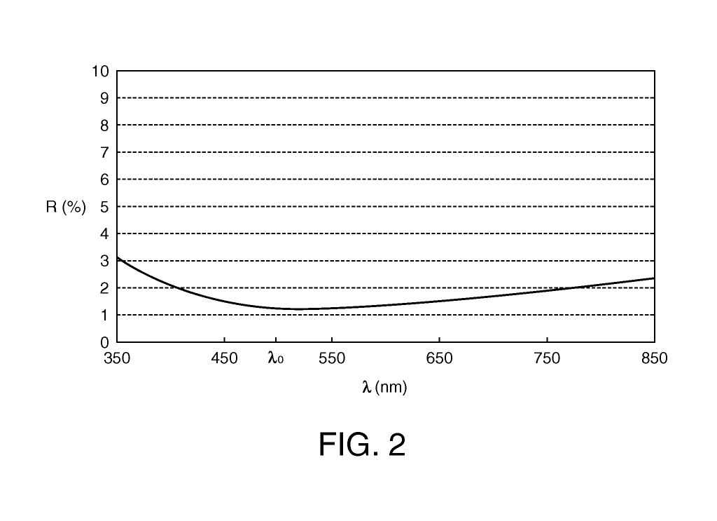

For example, in FIG. 2 which shows a relationship between a wavelength λ in a wavelength range of a light to be used and a reflectance R (%) of the organic antireflection layer 12, the wavelength λ₀ that provides the minimum reflectance R is 490 nm. When the refractive index n is set to be 1.36, which is the same as the refractive index of an antireflection film formed by a vacuum vapor deposition method in the related art, the thickness d is calculated to be 90 nm according to the above formula.

The thickness d of the organic antireflection layer 12 satisfies the following formula: 67 nm≦d≦151 nm. The wavelength range to be used varies depending on the various optical devices 1, and therefore, a specific range of the thickness d varies.

For example, in the case where the optical device 1 is used in a liquid crystal projector or a digital camera, the range is as follows: 80 nm≦d≦92 nm (d=86 nm median±7%), in the case where it is used in a pickup apparatus compatible with Blu-ray, the range is as follows: 67 nm≦d≦77 nm (d=72 nm median±7%), in the case where it is used in a pickup apparatus compatible with DVD, the range is as follows: 111 nm≦d≦127 nm (d=119 nm median±7%), and in the case where it is used in a pickup apparatus compatible with CD, the range is as follows: 131 nm≦d≦151 nm (d=141 nm median±7%).

### 4. Water-Repellent Film

The water-repellent film 13 is a layer composed of a fluorine-containing organosilicon compound. As the fluorine-containing organosilicon compound, a fluorine-containing silane compound represented by the following general formula (2) is preferably used.

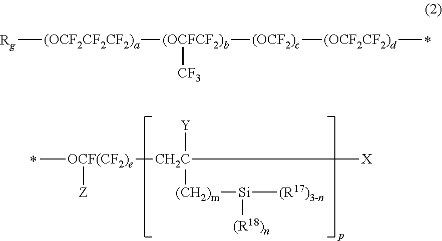

In the general formula (2), RG represents a linear or branched perfluoroalkyl group having 1 to 16 carbon atoms, but is preferably CF₃—, C₂F₅—, or C₃F₇—; X represents iodine or hydrogen; Y represents hydrogen or a lower alkyl group, Z represents fluorine or a trifluoromethyl group; R¹⁷ represents a hydrolyzable group, and is preferably, for example, a halogen, —OR¹⁹, —OCOR¹⁹, —OC(R¹⁹)═C(R²⁰)₂, —ON═C(R¹⁹)₂, or —ON═CR²¹. Here, R¹⁹ represents an aliphatic hydrocarbon group or an aromatic hydrocarbon group; R²⁰ represents hydrogen or a lower aliphatic hydrocarbon group; and R²¹ represents a divalent aliphatic hydrocarbon group having 3 to 6 carbon atoms.

R¹⁸ represents hydrogen or an inactive monovalent organic group, but is preferably a monovalent hydrocarbon group having 1 to 4 carbon atoms. a, b, c, and d each represent an integer of 0 to 200, but are preferably an integer of 1 to 50, and e represents 0 or 1. m and n each represent an integer of 0 to 2, but are preferably 0. p represents an integer of 1 or more, but is preferably an integer of 1 to 10. The molecular weight of the compound is from 5×10² to 1×10⁵, but is preferably from 5×10² to 1×10⁴.

Further, as a preferred structure of the fluorine-containing silane compound represented by the above general formula (2), a structure represented by the following general formula (3) can be exemplified. In the following formula, q represents an integer of 1 to 50, m represents an integer of 0 to 2, and r represents an integer of 1 to 10.

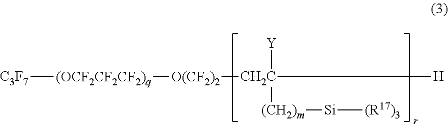

A method in which the fluorine-containing silane compound represented by the general formula (2) or (3) is dissolved in an organic solvent to form a water-repellent treatment liquid adjusted to contain the compound at a given concentration, and the formed water-repellent treatment liquid is coated on the organic antireflection layer can be adopted. As the coating method, a dip-coating method, a spin-coating method, a spray method, a flow method, a doctor blade method, a roll-coating method, a gravure-coating method, a curtain flow method, a brush-coating method, or the like can be used.

As the organic solvent, an organic compound, which has high solubility of the fluorine-containing silane compound, has a perfluoro group, and has 4 or more carbon atoms, is preferred, and examples thereof include perfluorohexane, perfluorocyclobutane, perfluorooctane, perfluorodecane, perfluoromethylcyclohexane, perfluoro-1,3-dimethylcyclohexane, perfluoro-4-methoxybutane, perfluoro-4-ethoxybutane, and metaxylene hexafluoride. In addition, a perfluoro ether oil or a chlorotrifluoroethylene oligomer oil can be used.

When the compound is diluted with the organic solvent, the concentration of the compound is preferably in a range of 0.03 to 1% by weight. If the concentration thereof is too low, it is difficult to form an antifouling layer having a sufficient thickness, and a sufficient water repellent and oil repellent effect may not be obtained in some cases. On the other hand, if the concentration thereof is too high, the thickness of the antifouling layer may be too large and a load of rinsing operation for eliminating coating unevenness after coating may be increased.

The thickness of the water-repellent film 13 is not particularly limited, but is preferably 0.001 μm or more and 0.5 μm or less, more preferably 0.001 μm or more and 0.3 or less.

In this embodiment, the water-repellent film may be formed by a vacuum vapor deposition method.

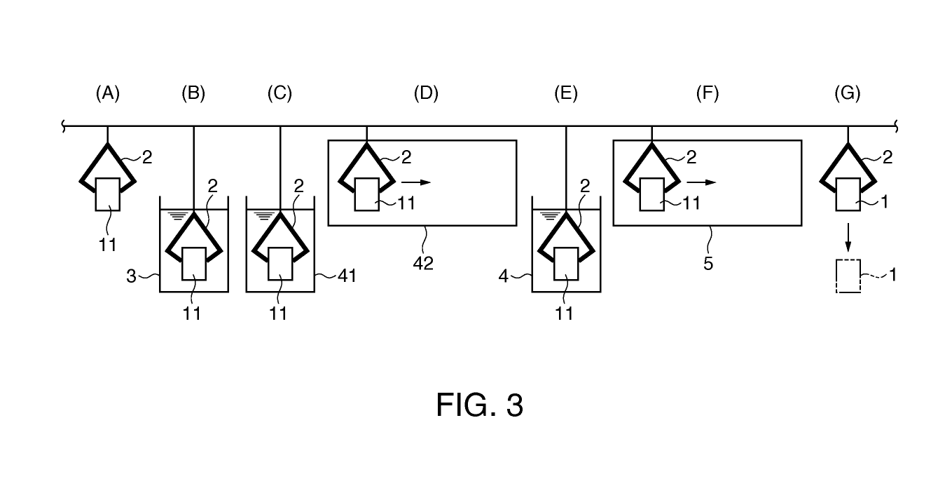

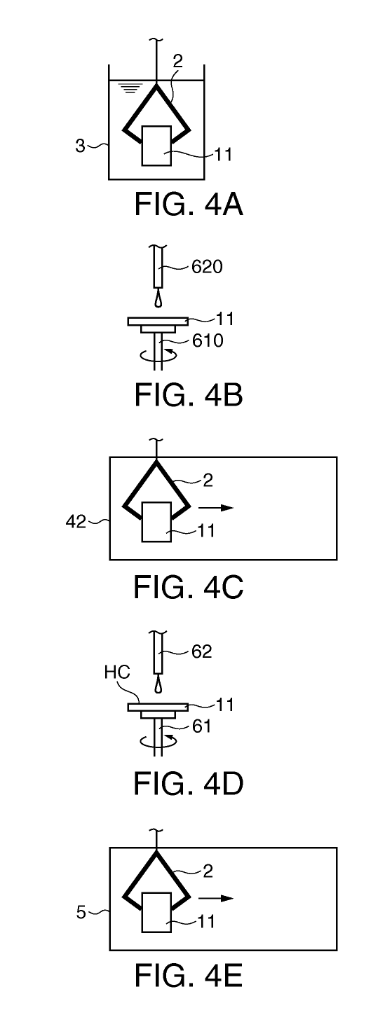

Next, an embodiment regarding a method for producing an optical device will be described with reference to FIG. 3 and FIGS. 4A to 4E.

First, an embodiment of forming an organic antireflection layer 12 by a dip-coating method will be described with reference to FIG. 3.

FIG. 3 is a schematic diagram for illustrating a line for producing an optical device 1.

### Preparation for Film Formation

As shown in (A) in FIG. 3, a light-transmissive base material 11 produced beforehand is set on a holding jig 2 that holds the light-transmissive base material 11. The horizontal and vertical size of the light-transmissive base material 11 is 50 mm×50 mm.

The light-transmissive base material 11 held by the holding jig 2 is washed by a washing apparatus 3 shown in (B) in FIG. 3. The light-transmissive base material 11 is washed with an alkali, and then, washed with pure water by the washing apparatus 3, and thereafter dried and left to cool.

Subsequently, as shown in (C) in FIG. 3, a composition for a hard coat layer is coated on the light-transmissive base material 11.

### Preparation of Composition for Hard Coat Layer

To 1000 parts by weight of butyl cellosolve, 1200 parts by weight of γ-glycidoxypropyltrimethoxysilane was added, and the resulting mixture was sufficiently stirred. Then, 300 parts by weight of 0.1 mol/L hydrochloric acid was added thereto, and the resulting mixture was continuously stirred for a whole day and night, whereby a silane hydrolysate was obtained. To this silane hydrolysate, 30 parts by weight of a silicone surfactant (trade name: L-7001, manufactured by Nippon Unicar Co., Ltd.) was added, and the resulting mixture was stirred for 1 hour. Thereafter, 7300 parts by weight of a composite fine particle sol composed mainly of titanium oxide, tin oxide, and silicon oxide (a rutile crystal structure, methanol dispersion, trade name: OPTOLAKE 1120Z 8RU-25, A17, manufactured by Catalysts & Chemicals Industries Co., Ltd.) was added thereto, followed by stirring and mixing for 2 hours. Then, 250 parts by weight of an epoxy resin (trade name: DENACOL EX-313, manufactured by Nagase Chemicals Ltd.) was added thereto, followed by stirring for 2 hours, and thereafter 20 parts by weight of iron (III) acetyl acetonate was added thereto, followed by stirring for 1 hour. The resulting mixture was filtered through a 2-μm filter, whereby a composition for a hard coat layer was obtained. The prepared composition for a hard coat layer is put in a solution bath 41.

Coating with Composition for Hard Coat Layer

The light-transmissive base material 11 held by the holding jig 2 is dipped in the composition for a hard coat layer put in the solution bath 41, and then, lifted from the bath at a lifting speed of 100 mm/min or more and 600 mm/min or less, for example, 150 mm/min.

### Firing

As shown in (D) in FIG. 3, the light-transmissive base material 11 coated with the composition for a hard coat layer is put in a firing furnace 42. In the firing furnace 42, the light-transmissive base material 11 is heated at a given temperature. This heating temperature is determined in consideration of the formulation of the composition for a hard coat layer, the heat resistance of the light-transmissive base material 11, and the like, but is 40° C. or higher and 200° C. or lower, for example, 150° C. The light-transmissive base material 11 is conveyed through the inside of the firing furnace 42 over a given time.

In this manner, a hard coat layer HC is formed on a principal surface of the light-transmissive base material 11.

Thereafter, as shown in (E) in FIG. 3, a composition for an antireflection film is coated on the hard coat layer HC on the light-transmissive base material 11.

### Solution: Preparation of Composition for Antireflection Film

An organosilicon compound serving as the “Component A1” is diluted with an organic solvent, and an organosilicon compound serving as the “Component A2” is added thereto. Then, a dispersion in which silica-based fine particles serving as the “Component A3” are dispersed in an organic solvent in a colloidal state is added thereto. Thereafter, if necessary, a curing catalyst, a photopolymerization initiator, an acid generating agent, a surfactant, a UV absorbing agent, an antioxidant, or the like is added, and the resulting mixture is sufficiently stirred, followed by hydrolysis by adding an aqueous nitric acid solution, a dilute hydrochloric acid solution, acetic acid, or the like.

At this time, as for the concentration of the diluted liquid with respect to the solid content after curing, the solid content concentration is from 0.5 to 15% by weight, for example, 2% by weight. If the solid content concentration exceeds 15% by weight, even if the lifting speed is decreased in the dipping method, it is difficult to obtain a given film thickness, and the thickness d of the organic antireflection layer 12 becomes larger than necessary. On the other hand, if the solid content concentration is less than 0.5% by weight, even if the lifting speed is increased in the dipping method, the thickness d becomes smaller than necessary.

The prepared composition for an antireflection film is put in a pot 4.

Coating with Composition for Antireflection Film

The light-transmissive base material 11 held by the holding jig 2 is dipped in the composition for an antireflection film put in the pot 4, and then, lifted from the pot at a lifting speed of 100 mm/min or more and 600 mm/min or less, for example, 150 mm/min.

### Firing

As shown in (F) in FIG. 3, the light-transmissive base material 11 coated with the composition for an antireflection film is put in a firing furnace 5. In the firing furnace 5, the light-transmissive base material 11 is heated at a given temperature. This heating temperature is determined in consideration of the formulation of the composition for an antireflection film, the heat resistance of the light-transmissive base material 11, and the like, but is 50° C. or higher and 200° C. or lower, for example, 150° C. The light-transmissive base material 11 is conveyed through the inside of the firing furnace 5 over a period of time between 3 minutes and 8 minutes, for example, 5 minutes. That is, the composition for an antireflection film coated on the light-transmissive base material 11 is heated at a given temperature, for example 150° C. for a given time, for example 5 minutes.

As shown in (G) in FIG. 3, on both of the principal surfaces of the light-transmissive base material 11 discharged from the firing furnace 5, the organic antireflection layer 12 is formed, whereby an optical device 1 is completed. The water contact angle of the organic antireflection layer 12 of the completed optical device 1 was measured and found to be larger than 80°. On the other hand, the contact angle of an antireflection film composed of an inorganic material in the related art was measured and found to be smaller than 15°.

In this embodiment, on the surface of the organic antireflection layer 12, a water-repellent film 13 may be provided as needed.

Next, an embodiment of forming an organic antireflection layer 12 by a spin-coating method will be described with reference to FIGS. 4A to 4E.

FIGS. 4A to 4E are schematic diagrams for illustrating a method for producing an optical device 1.

Preparation for Film Formation

A light-transmissive base material 11 held by a holding jig 2 is washed by a washing apparatus 3 shown in FIG. 4A. That is, in the same manner as in the case of using a dip-coating method, the light-transmissive base material 11 is washed with an alkali, and then, washed with pure water, and thereafter dried and left to cool.

Coating with Composition for Hard Coat Layer

Subsequently, a composition for a hard coat layer prepared in the same manner as in the embodiment shown in FIG. 3 is coated on a principal surface of the light-transmissive base material 11 by a spin-coating method.

That is, as shown in FIG. 4B, the light-transmissive base material 11 is placed on a rotary table 610, and a solution which is the composition for a hard coat layer is dropped from a nozzle 620 onto a principal surface of the light-transmissive base material 11 in an amount of 0.5 mL or more and 1.5 mL or less, for example, 1 mL, and thereafter, the light-transmissive base material 11 is rotated by the rotary table 610 at a rotation speed of 1000 rpm or more and 2000 rpm or less, for example, 1500 rpm for 10 seconds or more and 30 seconds or less, for example 20 seconds.

### Firing

As shown in FIG. 4C, the light-transmissive base material 11 coated with the composition for a hard coat layer is put in a firing furnace 42. The firing condition is the same as in the case of using a dip-coating method.

In the case where the hard coat layer HC is formed on both of the principal surfaces of the light-transmissive base material 11, the coating of a principal surface of the light-transmissive base material 11 on the side where the hard coat layer HC is not formed with the composition for a hard coat layer (shown in FIG. 4B), and firing (shown in FIG. 4C) are performed.

On both or one of the principal surfaces of the light-transmissive base material 11 discharged from the firing furnace 42, the hard coat layer HC was formed.

Coating with Solution of Composition for Antireflection Film

Subsequently, a solution prepared in the same manner as in the embodiment shown in FIG. 3, i.e., a composition for an antireflection film is coated on a principal surface of the hard coat layer HC of the light-transmissive base material 11 by a spin-coating method.

That is, as shown in FIG. 4D, the light-transmissive base material 11 is placed on a rotary table 61, and the composition for an antireflection film is dropped from a nozzle 62 onto a principal surface of the hard coat layer HC formed on the light-transmissive base material 11 in an amount of 0.5 mL or more and 1.5 mL or less, for example, 1 mL, and thereafter, the light-transmissive base material 11 is rotated by the rotary table 61 at a rotation speed of 1000 rpm or more and 2000 rpm or less, for example, 1500 rpm for 10 seconds or more and 30 seconds or less, for example 20 seconds.

### Firing

As shown in FIG. 4E, the light-transmissive base material 11 coated with the composition for an antireflection film is put in a firing furnace 5. The firing condition is the same as in the case of using a dip-coating method.

In the case where the organic antireflection layer is formed on both of the principal surfaces of the light-transmissive base material 11, the coating of a principal surface of the light-transmissive base material 11 on the side where the organic antireflection layer 12 is not formed with the composition for an antireflection film (shown in FIG. 4D), and firing (shown in FIG. 4E) are performed.

On both or one of the principal surfaces of the light-transmissive base material 11 discharged from the firing furnace 5, the organic antireflection layer 12 having the same contact angle as in the case of using a dip-coating method was formed. Incidentally, on the surface of the organic antireflection layer 12, a water-repellent film 13 may be provided as needed.

Accordingly, in this embodiment, the following operational effects can be exhibited.

(1) Since the following configuration is adopted, the disadvantage of using a vacuum vapor deposition method for film formation can be avoided: the hard coat layer HC composed of an inorganic material is provided on the light-transmissive base material 11 composed of an inorganic material, the organic antireflection layer 12 is provided on this hard coat layer HC, and this organic antireflection layer 12 contains an organosilicon compound, an epoxy group-containing organic compound, and hollow silica, and contains a Si skeleton having an atomic structure including a siloxane (Si—O) bond and a leaving group binding to the Si skeleton, and a dangling bond of the Si skeleton from which the leaving group has been released among the Si skeletons becomes an active hand to bond a principal surface of the light-transmissive base material 11 through a siloxane bond or a covalent bond. That is, a factor causing the adhesion of dirt, dust, etc. to a principal surface of the light-transmissive base material 11 during film formation is significantly decreased, and thus, the occurrence of a defect in the organic antireflection layer 12 of the optical device 1 can be prevented. Further, since the contact angle of the organic antireflection layer 12 is larger than that of an antireflection film made of an inorganic material, the dust-proof effect becomes larger than that of an antireflection film made of an inorganic material, and therefore, dirt, dust, etc. are less likely to adhere thereto. Further, the organic antireflection layer 12 does not contain a mixed oxide of titanium and lanthanum, and therefore, uranium (U) or thorium (Th), each of which is a radioactive element, is not contained in the material as impurities, and thus, there are no adverse effects on an electrical component which is disposed near the optical device 1.

(2) Since the thickness d of the organic antireflection layer 12 is set to satisfy the formula: d=λ/(4×n), an organic antireflection layer 12 having a high antireflection effect can be provided.

(3) Since the thickness d of the organic antireflection layer 12 is set to satisfy the formula: 80 nm≦d≦92 nm in the case where the optical device 1 is used in a liquid crystal projector or a camera; 67 nm≦d≦77 nm in the case where it is used in a pickup apparatus compatible with Blu-ray; 111 nm≦d≦127 nm in the case where it is used in a pickup apparatus compatible with DVD; and 131 nm≦d≦151 nm in the case where it is used in a pickup apparatus compatible with CD, a high antireflection effect of the organic antireflection layer 12 compatible with various types of optical products is obtained.

(4) Since quartz crystal, lithium niobate, or a glass, which is relatively easily obtained, is used as the inorganic material of the light-transmissive base material 11, the optical device 1 can be easily produced.

(5) If the light-transmissive base material 11 comprises a birefringent plate, the dust-proof effect of the birefringent plate can be enhanced.

(6) If the organic antireflection layer 12 is formed by applying a solution containing the composition for an antireflection film to the hard coat layer HC composed of an inorganic material using a dip-coating method, the film formation process can be more simply controlled than in the case of using a vacuum vapor deposition method, and therefore, the optical device 1 can be easily produced. That is, it is only necessary to dip the light-transmissive base material 11 having the hard coat layer HC formed thereon in the composition for an antireflection film, and therefore, a complicated process as in the case of using a vacuum vapor deposition method is no longer necessary.

(7) If the organic antireflection layer 12 is formed by applying the composition for an antireflection film to the hard coat layer HC composed of an inorganic material using a spin-coating method, the thickness of the organic antireflection layer 12 can be more easily adjusted than in the case of using a dip-coating method. That is, by adjusting the rotation speed and rotation time of the light-transmissive base material 11, and the amount of the composition for an antireflection film to be dropped onto the light-transmissive base material 11, the thickness d of the organic antireflection layer 12 can be easily controlled.

(8) Since the number of steps and the time required for film formation after washing are reduced as compared with the case of using a vacuum vapor deposition method by forming the hard coat layer HC and the organic antireflection layer on the light-transmissive base material 11 using a dip-coating method or a spin-coating method after washing the light-transmissive base material 11, the film formation is performed in a state where dirt or dust does not adhere to the principal surface of the light-transmissive base material 11. Therefore, also from this point of view, the occurrence of a defect in the organic antireflection layer 12 can be eliminated.

(9) If a fluorine-based water-repellent film 13 is provided on the organic antireflection layer 12, the dust-proof performance of the optical element 1 can be improved also from this point of view.

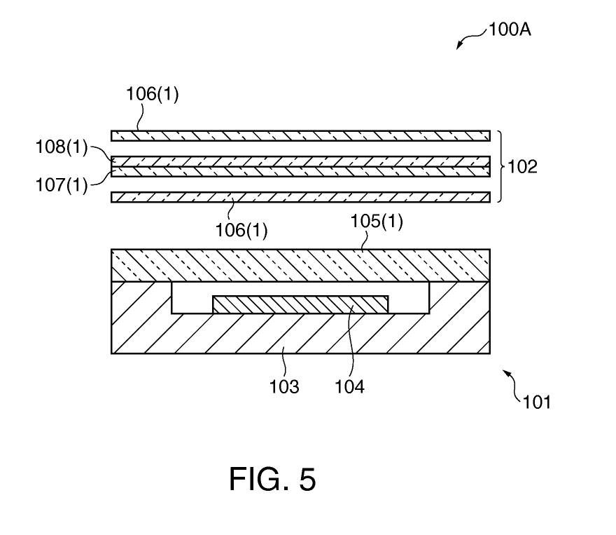

An embodiment of an image-capturing apparatus having the above-described optical device 1 incorporated therein will be described with reference to FIG. 5.

FIG. 5 shows an image-capturing apparatus having the optical device produced according to this embodiment incorporated therein.

In FIG. 5, an image-capturing apparatus 100A is used in a digital camera, a video camera, an electronic still camera, or other camera, and is provided with an image-capturing assembly 101 and an optical low-pass filter group 102, which are disposed facing each other.

The image-capturing assembly 101 is provided with a container 103 made of a ceramic, a plate-shaped image-capturing device 104 disposed in a central portion of this container 103, a lid 105 which is disposed facing this image-capturing device 104 and adhesively fixed to the container 103 at an outer peripheral portion thereof. The image-capturing device 104 is composed of CCD, C-MOS, or the like.

The optical low-pass filter group 102 is composed of a birefringent plate 106, an infrared absorbing glass 107, a ¼ wave plate 108, a birefringent plate 106, etc.

The members constituting the image-capturing apparatus 100A such as the lid 105, the birefringent plate 106, the infrared absorbing glass 107, and the ¼ wave plate 108, and also the optical products not shown in the drawings and provided in a digital camera or other camera other than the image-capturing apparatus 100A are the optical device 1 according to this embodiment.

Accordingly, in this embodiment, the following operational effect can be exhibited.

(10) Since the image-capturing apparatus 100A is configured to include the optical device 1 having the organic antireflection layer 12 provided on a principal surface of the light-transmissive base material 11, the image-capturing device 104, and the container 103 which houses the image-capturing device 104, the organic antireflection layer 12 of the optical device 1 does not have a defect, and also a dust-proof effect is high. Accordingly, reflection of a defect, dirt, etc. on the image-capturing device 104 can be prevented.

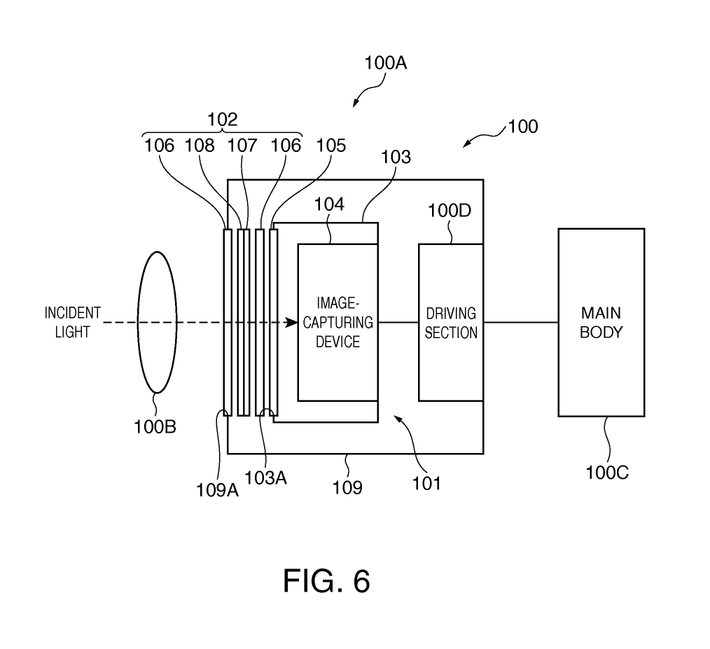

Embodiments of an electronic apparatus having the above-described optical device 1 incorporated therein will be described with reference to FIGS. 6 to 8.

FIG. 6 shows a schematic diagram of a camera such as a digital still camera or a digital video camera as one example of an electronic apparatus.

In FIG. 6, a camera 100 serving as an electronic apparatus is provided with the above-described image-capturing apparatus 100A, a lens 100B disposed on the light incident side of this image-capturing apparatus 100A, and a main body 100C disposed on the light exit side of this image-capturing apparatus 100A.

The main body 100C includes a variety of constituent components such as a signal-processing section that performs correction of an image-capturing signal, etc., a recording section that records the image-capturing signal on a recording medium such as a magnetic tape, a reproducing section that reproduces this recorded image-capturing signal, and a display section that displays the reproduced image.

The image-capturing apparatus 100A includes a housing case 109.

In the housing case 109, the above-described image-capturing assembly 101 and a driving section 100D are disposed. The driving section 100D drives the image-capturing device 104.

The image-capturing assembly 101 is configured to include a container 103, an image-capturing device 104, and a lid 105, and in FIG. 6, a window 103A that holds the lid 105 is provided in the container 103.

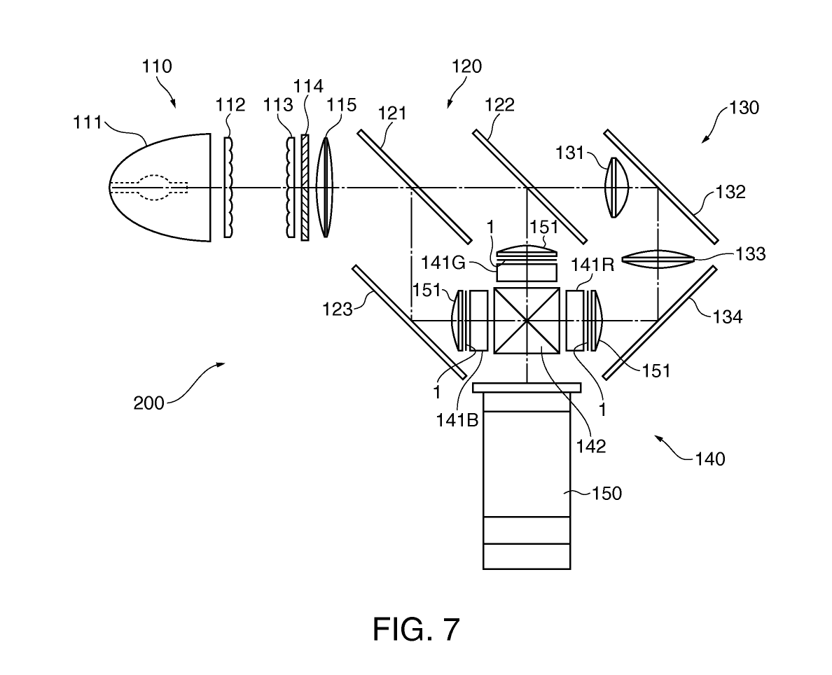

FIG. 7 shows a schematic diagram of a liquid crystal projector as one example of an electronic apparatus.

In FIG. 7, a projector 200 is provided with an integrator illumination optical system 110, a color separation optical system 120, a relay optical system 130, an electro-optical device 140, and a projection lens 150.

The integrator illumination optical system 110 is provided with a light source 111, a first lens array 112, a second lens array 113, a polarization conversion element 114, and a superimposing lens 115. This integrator illumination optical system 110 substantially uniformly illuminates the image forming regions of three transmissive liquid crystal panels 141 (liquid crystal panels 141R, 141G, and 141B for respective light components of red, green, and blue) constituting the electro-optical device 140.

The color separation optical system 120 is provided with two dichroic mirrors 121 and 122 and a reflecting mirror 123. This color separation optical system 120 separates a plurality of partial light fluxes emitted from the integrator illumination optical system 110 into light components of three colors of red (R), green (G), and blue (B) by the dichroic mirrors 121 and 122.

The dichroic mirror 121 and the reflecting mirror 123 guide a blue light component to the transmissive liquid crystal panel 141B.

The dichroic mirror 122 guides a green light component among a red light component and a green light component transmitted through the dichroic mirror 121 to the transmissive liquid crystal panel 141G through a field lens 151.

The relay optical system 130 guides a red light component transmitted through the dichroic mirror 122 to the transmissive liquid crystal panel 141R through an incident-side lens 131, a relay lens 133, and reflecting mirrors 132 and 134.

The electro-optical device 140 modulates incident light fluxes in accordance with image information to form a color image. This electro-optical device 140 is provided with the transmissive liquid crystal panels 141R, 141G, and 141B, dust-proof glasses 1 which are the optical devices according to this embodiment and are provided on the light incident surfaces of the respective transmissive liquid crystal panels 141R, 141G, and 141B, and a cross dichroic prism 142.

The dust-proof glasses 1 are disposed on optical paths between the light source 111 and the cross dichroic prism 142, and the cross dichroic prism 142 combines the optical images modulated for the respective color light components to form a color image.

The projection lens 150 projects the color image formed by the cross dichroic prism 142 in an enlarged form.

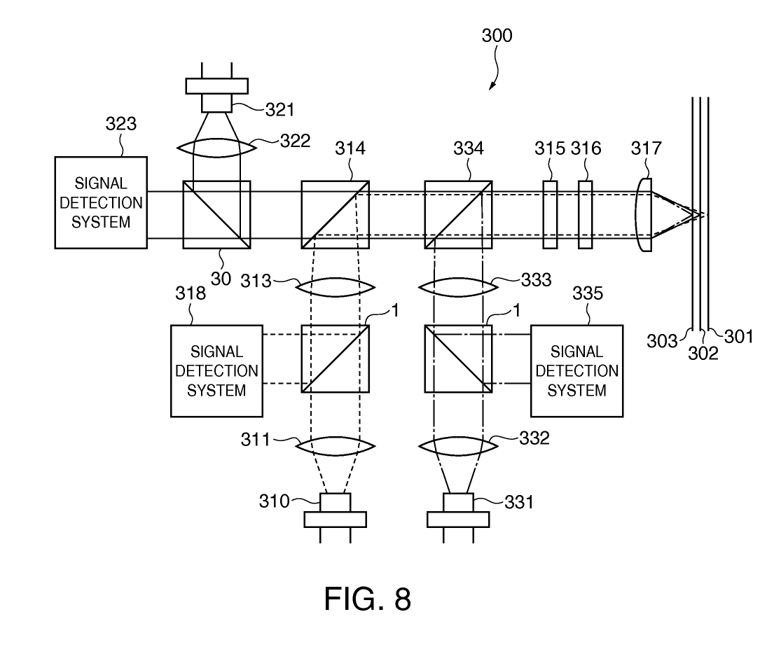

FIG. 8 shows a schematic diagram of an optical pickup apparatus as one example of an electronic apparatus.

In FIG. 8, an optical pickup apparatus 300 is configured to irradiate three types of laser beams having different wavelengths onto three types of optical disks (CD 301, DVD 302, and BD 303) serving as optical recording media having different focal positions and to detect given signals, respectively.

Specifically, the optical pickup apparatus 300 is configured to include, as an optical system in relation to the CD 301, a laser diode 310 that generates a laser beam, a collimator lens 311, a polarization beam splitter 1, which is the optical device according to this embodiment, a lens 313, a dichroic prism 314, a ¼ wave plate 315, an opening filter 316, an objective lens 317, and a signal detection system 318 that detects a signal written in data pits of the CD 301 by receiving a reflected laser light reflected from the data pits and converting the light into an electrical signal.

The optical pickup apparatus 300 is configured to include, as an optical system in relation to the DVD 302, an LD 321 that generates a laser beam, a lens 322, a polarization beam splitter 1, and a signal detection system 323 that detects a signal written in data pits of the DVD 302 by receiving a reflected laser light reflected from the data pits and converting the light into an electrical signal.

The optical pickup apparatus 300 is configured to include, as an optical system in relation to the BD 303, an LD 331 that generates a laser beam, a lens 332, a polarization beam splitter 1, a lens 333, a dichroic prism 334, and a signal detection system 335 that detects a signal written in data pits of the BD 303 by receiving a reflected laser light reflected from the data pits and converting the light into an electrical signal.

The outline structure of the polarization beam splitter 1 is the same as that of the optical device 1 shown in FIG. 1 except for the shape of the substrate.

(11) Since the electronic apparatuses, that is, the camera 100, the liquid crystal projector 200, and the optical pickup apparatus 300 are configured to include the optical device 1 having the organic antireflection layer 12 provided on a principal surface of the light-transmissive base material 11, high-quality electronic apparatuses without causing reflection of dirt, etc. can be provided.

The invention is not limited to the above-described embodiments, and the following modifications within a range that can achieve the object of the invention are also included in the invention.

For example, in the above-described embodiments, as the light-transmissive base material 11, a plate-shaped base material is used, however, in the invention, those having a spherical surface may be used. That is, the optical device of the invention is not limited to those in the form of a plate such as a birefringent plate or a lid, but can also be applied to a lens to be used in electronic apparatuses.

Further, the step of washing the light-transmissive base material 11 performed prior to film formation may be configured such that a plurality of the light-transmissive base materials 11 are put in a basket or the like, and washed at one time.

Still further, as the method for coating the composition for a hard coat layer, a dip-coating method and a spin-coating method are used in the above-described embodiments, however, in the invention, a spray-coating method, a roll-coating method, or a flow-coating method can be used.

The invention can be utilized in electronic apparatuses including an optical device such as a digital camera, a liquid crystal projector, and an optical pickup apparatus.

The entire disclosure of Japanese Patent Application No. 2012-089616, filed Apr. 10, 2012 is expressly incorporated by reference herein.

What is claimed is:

1. An optical device comprising:
an inorganic light-transmissive base material;
an inorganic hard coat layer, which is provided on a principal surface of the light-transmissive base material and is harder than the light-transmissive base material; and
an organic antireflection layer, which is provided on a principal surface of the hard coat layer and contains an organosilicon compound, an epoxy group-containing organic compound, and hollow silica, wherein
the hard coat layer and at least one of the organosilicon compound and the epoxy group-containing organic compound are covalently bonded to each other.

2. The optical device according to claim 1, wherein the thickness d of the organic antireflection layer satisfies the following formula: d=λ/(4×n), wherein n represents the refractive index of the organic antireflection layer and λ represents the wavelength of a transmitted light.

3. The optical device according to claim 2, wherein the thickness d of the organic antireflection layer satisfies the following formula: 67 nm≦d≦151 nm.

4. The optical device according to claim 1, wherein the light-transmissive base material contains an Si group.

5. An image-capturing apparatus, comprising:
the optical device according to claim 1;
an image-capturing device; and
a container which houses the image-capturing device.

6. An image-capturing apparatus, comprising:
the optical device according to claim 2;
an image-capturing device; and
a container which houses the image-capturing device.

7. An image-capturing apparatus, comprising:
the optical device according to claim 3;
an image-capturing device; and
a container which houses the image-capturing device.

8. An electronic apparatus, comprising the optical device according to claim 1.

9. An electronic apparatus, comprising the optical device according to claim 2.

10. An electronic apparatus, comprising the optical device according to claim 3.

11. A method for producing an optical device, comprising:
preparing an inorganic light-transmissive base material and forming an inorganic hard coat layer, which is harder than the light-transmissive base material, on a principal surface of the light-transmissive base material;
preparing a solution bath containing a solution containing an organosilicon compound, an epoxy group-containing organic compound, and hollow silica;
dipping the light-transmissive base material having the hard coat layer formed thereon in the bath to coat the hard coat layer with the solution; and
heating the light-transmissive base material having the hard coat layer coated with the solution so as to covalently bond the hard coat layer to at least one of the organosilicon compound and the epoxy group-containing organic compound.

12. A method for producing an optical device, comprising:
preparing an inorganic light-transmissive base material and forming an inorganic hard coat layer, which is harder than the light-transmissive base material, on a principal surface of the light-transmissive base material;
preparing a solution containing an organosilicon compound, an epoxy group-containing organic compound, and hollow silica;
applying and spin-coating the solution onto the hard coat layer; and
heating the light-transmissive base material having the hard coat layer spin-coated with the solution so as to covalently bond the hard coat layer to at least one of the organosilicon compound and the epoxy group-containing organic compound.
